(19) United States
(12) Patent Application Publication
(10) Pub. No.: US 2003/0036933 A1
(43) Pub. Date: Feb. 20, 2003

(54) System and method for business goal-optimization when customer demand cannot be satisfied

(75) Inventors: Ravindra K. Shetty, Bangalore (IN); Venkatesan Thyagarajan, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 09/893,091

(22) Filed: Jun. 27, 2001

(51) Int. Cl. G06F 17/60

(52) U.S. Cl. 705/7; 705/10; 705/28

(57) ABSTRACT

Systems and methods are provided through which the quantity of one or more items in a customer order are reduced in reference to a function of inverse probability of vendor profit and in reference to a reasonable margin of a target time predetermined by the customer, when the customer order cannot be produced within the margin. The reduced item quantities update the corresponding items in the customer order, and the items in the customer order are produced accordingly, such that the objective of the business goal is met or not sacrificed.

### FIELD OF THE INVENTION

This invention relates generally to management of inventory and production, and more particularly to management of an individual customer order to maximize profit.

### BACKGROUND OF THE INVENTION

In conventional production management systems typically implement linear programming, quadratic programming and/or pure probability analysis to determine the most profitable mix of products. The systems attempt to determine the combination of products in a customer order based on vendor product supply constraints that is most profitable to the vendor. Linear programming is a procedure for finding the maximum or minimum of a linear function of profitability wherein the arguments are subject to linear constraints. Quadrature programming is a variant of linear programming in which the objective function is quadratic rather than linear. Probability based analysis ends up with likely hood of an event occurring solution. However, these methods do not provide sufficiently effective solutions to business goals of the vendor, such as cost minimization, and profit maximization. Solutions using Linear programming, quadrature programming are works with rule based and solutions using pure probability works with likelihood based concepts. These less effective solutions yield reduced customer satisfaction and/or reduced vendor profits, both of which are unacceptable.

For the reasons stated above, and for other reasons stated below which will become apparent to those skilled in the art upon reading and understanding the present specification, there is a need in the art for a system of selecting a mix of products that maximizes profit to the vendor.

### SUMMARY OF THE INVENTION

The above-mentioned shortcomings, disadvantages and problems are addressed by the present invention, which will be understood by reading and studying the following specification.

Systems and methods are provided through which the quantity of one or more items in a customer order are reduced in reference to a function of inverse probability of vendor profit and in reference to a reasonable margin of a target time predetermined by the customer, when the customer order cannot be produced within the margin. The reduced item quantities update the corresponding items in the customer order, and the items in the customer order are produced accordingly, such that the objective of the business goal is met or not sacrificed.

In one aspect of the present invention, a reduced quantity of a requested product quantity in a customer order is determined or calculated in reference to the inverse of the probability of profit of the product. The reduced quantity is communicated to a production management process. The requested product quantity is iteratively reduced from a time shortfall, from the inverse profit probability, and from a reduced number of a plurality of products, until the customer accepts the reduced quantity or until the time shortfall is non-existent.

In another aspect of the present invention, a computerized method for production management includes determining that at least one request for a plurality of products exceeds a production capacity of a vendor, wherein the request for a plurality of products includes a quantity associated with each of the plurality of products from process and inventory operation data and from customer order data. The method subsequently determines a quantity of each of the plurality of products that correspond to a vendor maximum profit of the requests for a plurality of products. The quantity is determined from a degradation of the quantity associated with at least one of the plurality of products.

In yet another aspect of the present invention, a computerized method for production management includes determining that at least one request for a plurality of products exceeds a production capacity of a vendor. The method also includes determining a profit probability from the profit of a production of one of the plurality of products in the request, and from the profit of all of the plurality of products in the customer order. Thereafter the method includes determining a graceful decrement from the time shortfall, from the profit probability, and from a decremented number of plurality of products. Thereafter, the objective value is updated from the graceful decrement and the actual quantity to be produced is determined for each of the plurality of products, from the graceful decrement and from the unit time of manufacture. Subsequently, the method includes determining an actual time to produce all of the plurality of products to be produced, from the actual quantity to be produced for each of the plurality of products.

In still another aspect of the present invention, a computerized apparatus for production management includes a demand analyzer that determines if a vendor can satisfy a quantity of customer demand for a product from a database of process and inventory operation data and from a database of customer order data. The method also includes a graceful quantity degrader, coupled to a demand analyzer that yields a degraded quantity from the quantity of customer demand using an inverse probability of profit function.

In still yet another aspect of the present invention, a computerized apparatus for production management includes an excess quantity determiner that determines that one or more customer requests for a plurality of products exceed a production capacity of the vendor within a prescribed time period; and the apparatus includes a reduced quantity determiner, operably coupled to the excess quantity determiner, that yields a reduced quantity, from an inverse probability of profit of the reduced quantity.

In still yet a further aspect of the present invention, a computerized apparatus for production management includes an excess quantity determiner, that determines that one or more customer requests for a plurality of products exceed a production capacity of the vendor within a prescribed time period. The apparatus also includes an inverse profit probability determiner, operably coupled to the excess quantity determiner. The inverse probability determiner yields an inverse profit probability from an inverse probability of profit of the reduced quantity. The inverse probability determiner is operably coupled to a gracefully-decremented quantity determiner, yielding a reduced quantity, wherein the gracefully-decremented quantity is determined for each of the products that a customer indicated a reduced quantity, and determined from a time shortfall, the inverse probability of profit, and from a decremented number of plurality of products.

The present invention describes systems, clients, servers, methods, databases, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of the hardware and operating environment in which different embodiments of the invention can be practiced.

FIG. 2 is a diagram illustrating a system-level overview of an embodiment of the invention.

FIG. 3 is a flowchart of a method for production management, according to an embodiment of the invention.

FIG. 4 is a flowchart of a method of determining that the customer order exceeds production capacity, according to an embodiment of the invention.

FIG. 5 is a flowchart of a method of determining production time, according to an embodiment of the invention.

FIG. 6 is a flowchart of a method of determining a quantity of each of the products corresponding to a vendor maximum profit, according to an embodiment of the invention.

FIG. 7 is a block diagram of an apparatus of an embodiment of the present invention.

FIG. 8 is a block diagram of apparatus for production management, according to an embodiment of the invention.

FIG. 9 is a block diagram of an apparatus for determining that the customer order exceeds production capacity.

FIG. 10 is a block diagram of a reduced quantity determiner, according to an embodiment of the invention.

### DETAILED DESCRIPTION OF THE INVENTION

In the following detailed description of embodiments of the invention, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention. The following detailed description is, therefore, not to be taken in a limiting sense, and the scope of the present invention is defined only by the appended claims.

The detailed description is divided into five sections. In the first section, the hardware and the operating environment in conjunction with which embodiments of the invention may be practiced are described. In the second section, a system level overview of the invention is presented. In the third section, methods for an embodiment of the invention are provided. In the fourth section, a particular object-oriented Internet-based implementation of the invention is described. Finally, in the fifth section, a conclusion of the detailed description is provided.

Hardware and Operating Environment

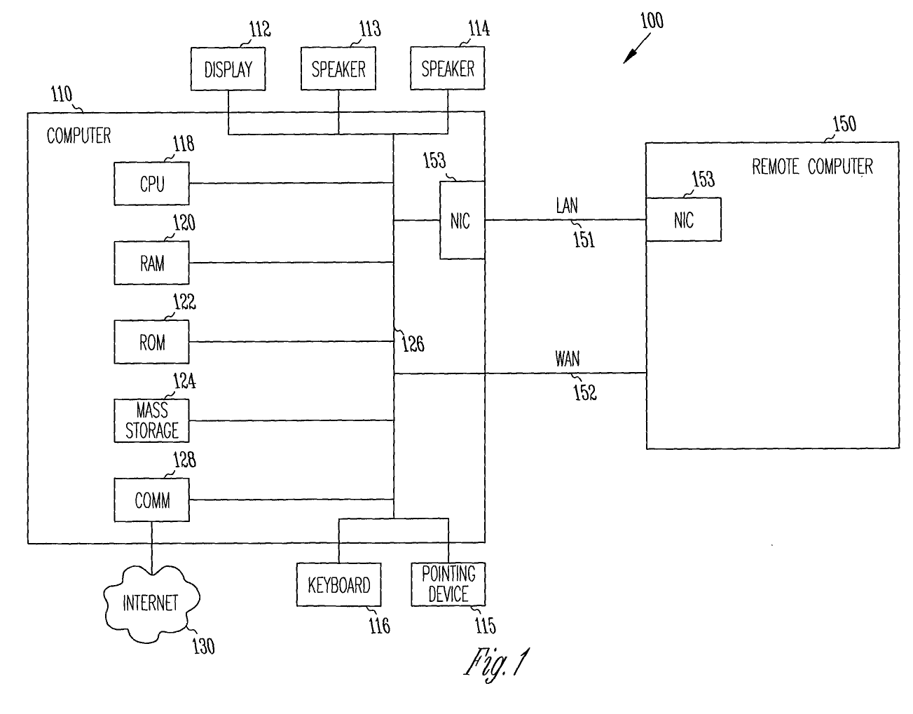

FIG. 1 is a block diagram of the hardware and operating environment 100 in which different embodiments of the invention can be practiced. The description of FIG. 1 provides an overview of computer hardware and a suitable computing environment in conjunction with which some embodiments of the present invention can be implemented. Embodiments of the present invention are described in terms of a computer executing computer-executable instructions. However, some embodiments of the present invention can be implemented entirely in computer hardware in which the computer-executable instructions are implemented in Read Only Memory. One embodiment of the invention can also be implemented in client/server computing environments where remote devices that are linked through a communications network perform tasks. Program modules can be located in both local and remote memory storage devices in a distributed computing environment.

Computer 110 is operatively coupled to display device 112, pointing device 115, and keyboard 116. Computer 110 includes a processor 118, commercially available from Intel®, Motorola®, Cyrix®, and others, Random Access Memory (RAM) 120, Read Only Memory (ROM) 122, and one or more mass storage devices 124, and a system bus 126, that operatively couples various system components including the system memory to the processing unit 118. Mass storage devices 124 are more specifically types of nonvolatile storage media and can include a hard disk drive, a floppy disk drive, an optical disk drive, and a tape cartridge drive. The memory 120, 122, and mass storage devices, 124, are types of computer-readable media. A user enters commands and information into the computer 110 through input devices such as a pointing device 115 and a keyboard 116. Other input devices (not shown) can include a microphone, joystick, game pad, satellite dish, scanner, or the like. The processor 118 executes computer programs stored on the computer-readable media. Embodiments of the present invention are not limited to any type of computer 110. In varying embodiments, computer 110 comprises a PC-compatible computer, a MacOS®-compatible computer or a UNIX®-compatible computer. The construction and operation of such computers are well known within the art.

Furthermore, computer 110 can be communicatively connected to the Internet 130 via a communication device 128. Internet 130 connectivity is well known within the art. In one embodiment, a communication device 128 is a modem that responds to communication drivers to connect to the Internet via what is known in the art as a “dial-up connection.” In another embodiment, a communication device 128 is an Ethernet® or similar hardware (network) card connected to a Local Area Network (LAN) that itself is connected to the Internet via what is known in the art as a “direct connection” (e.g., T1 line, etc.).

Computer 110 can be operated using at least one operating environment to provide a graphical user interface including a user-controllable pointer. Such operating environments include operating systems such as versions of the Microsoft Windows® and Apple MacOS® operating systems well-known in the art. Embodiments of the present invention are not limited to any particular operating environment, however, and the construction and use of such operating environments are well known within the art. Computer 110 can have at least one web browser application program executing within at least one operating environment, to permit users of computer 110 to access intranet or Internet world-wide-web pages as addressed by Universal Resource Locator (URL) addresses. Such browser application programs include Netscape Navigator® and Microsoft Internet Explorer®.

Display device 112 permits the display of information, including computer, video and other information, for viewing by a user of the computer. Embodiments of the present invention are not limited to any particular display device 112. Such display devices include cathode ray tube (CRT) displays (monitors), as well as flat panel displays such as liquid crystal displays (LCD's). Display device 112 is connected to the system bus 126. In addition to a monitor, computers typically include other peripheral input/output devices such as printers (not shown), speakers, pointing devices and a keyboard. Speakers 113 and 114 enable the audio output of signals. Speakers 113 and 114 are also connected to the system bus 126. Pointing device 115 permits the control of the screen pointer provided by the graphical user interface (GUI) of operating systems such as versions of Microsoft Windows®. Embodiments of the present invention are not limited to any particular pointing device 115. Such pointing devices include mouses, touch pads, trackballs, remote controls and point sticks. Finally, keyboard 116 permits entry of textual information into computer 110, as known within the art, and embodiments of the present invention are not limited to any particular type of keyboard.

The computer 110 can operate in a networked environment using logical connections to one or more remote computers, such as remote computer 150. A communication device coupled to, or a part of, the computer 110 achieves these logical connections. Embodiments of the present invention are not limited to a particular type of communications device. The remote computer 150 can be another computer, a server, a router, a network PC, a client, a peer device or other common network node. The logical connections depicted in FIG. 1 include a Local Area Network (LAN) 151 and a wide-area network (WAN) 152. Such networking environments are commonplace in offices, enterprise-wide computer networks, intranets and the Internet.

When used in a LAN-networking environment, the computer 110 and remote computer 150 are connected to the local network 151 through a network interface or adapter 153, which is one type of communications device. When used in a conventional WAN-networking environment, the computer 110 and remote computer 150 communicate with a WAN 152 through modems (not shown). The modem, which can be internal or external, is connected to the system bus 126. In a networked environment, program modules depicted relative to the computer 110, or portions thereof, can be stored in the remote memory storage device.

System Level Overview

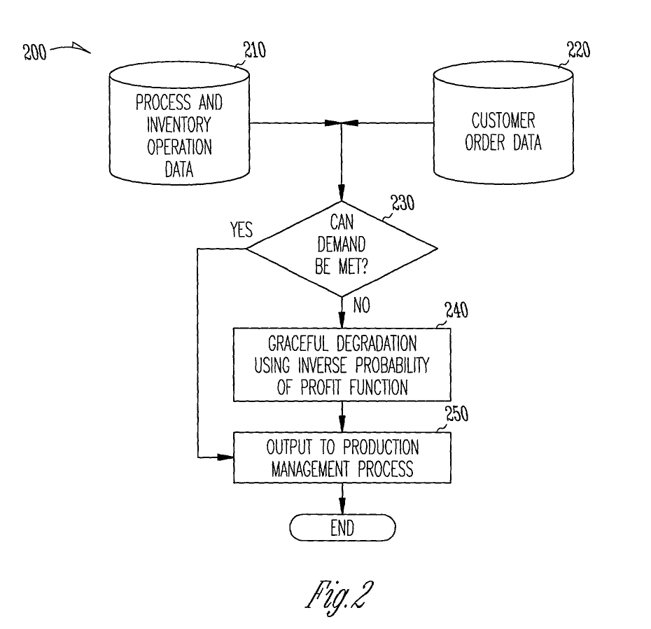

FIG. 2 is a block diagram that provides a system level overview of the operation of embodiments of the present invention. Embodiments of the invention are described as operating in a multi-processing, multi-threaded operating environment on a computer, such as computer 110 in FIG. 1.

System 200 includes a database that includes process and inventory operation data 210. System 200 also includes a database that includes customer order data 220. The process and inventory operation data 210 and the customer order data 220 are analyzed to determine if the vendor can meet the customer product demand 230. If yes, then the customer order data 220 is transmitted to a production management process 250. If no, then the quantities in the customer order are gracefully degraded using an inverse probability of profit function 240. The graceful degradation attains certainty that the order will be fulfilled, and in reference to a profit from each of the products in the order. Hence, system 200 assures meeting a target value of an objective, while also completing the best possible efforts to meet the production demands from the customer.

System 200 has application in every industry that practices production and/or delivery management, such as petrochemical processing, chemical processing, pharmaceutical manufacturing, retail sales, service scheduling, such as airline crew scheduling, and supply chain management.

The system level overview of the operation of an embodiment of the invention has been described in this section of the detailed description. The present invention reduces the quantity of a product in a customer order, in reference to the inverse of the profit probability. While the invention is not limited to any particular product or type of product, for sake of clarity a generic product has been described.

Methods of an Embodiment of the Invention

In the previous section, a system level overview of the operation of an embodiment of the invention was described. In this section, the particular methods performed by the server and the clients of such an embodiment are described by reference to a series of flowcharts. Describing the methods by reference to a flowchart enables one skilled in the art to develop such programs, firmware, or hardware, including such instructions to carry out the methods on suitable computerized clients (the processor of the clients executing the instructions from computer-readable media). Similarly, the methods performed by the server computer programs, firmware, or hardware are also composed of computer-executable instructions. Methods 300-600 are performed by a client program executing on, or performed by firmware or hardware that is a part of, a computer, such as computer 110 in FIG. 1.

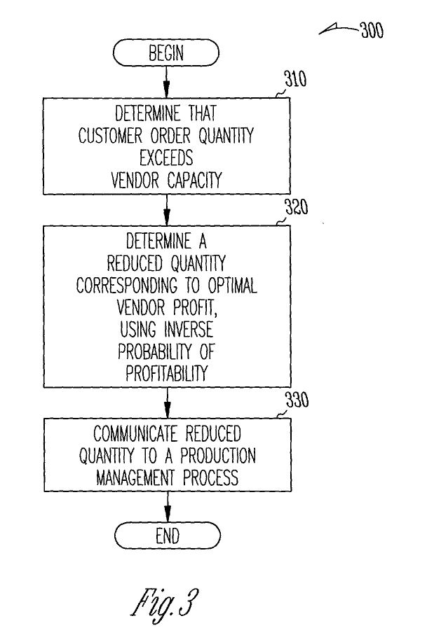

FIG. 3 is a flowchart of a method 300 for production management, according to an embodiment of the invention. Method 300 enables a vendor to optimize or maximize profit from a customer order when the vendor cannot meet demand for at least one of the products in the order.

Method 300 includes determining 310 that one or more requests from the customer, for a plurality of products, exceed a production capacity of the vendor. The request includes a quantity that is associated with each of a plurality of products identified in the order. The request is from customer order data that originates at the customer. Method 300 thereafter includes determining 320 a reduced quantity of each of the plurality of products that corresponds to a vendor maximum profit. The reduced quantity is determined from a degradation of the quantity associated with at least one of the plurality of products, using an inverse probability of profitability. In one embodiment, method 300 subsequently includes communicating 330 the reduced quantity of each of the plurality of products to a production management process. In another embodiment, the products are services.

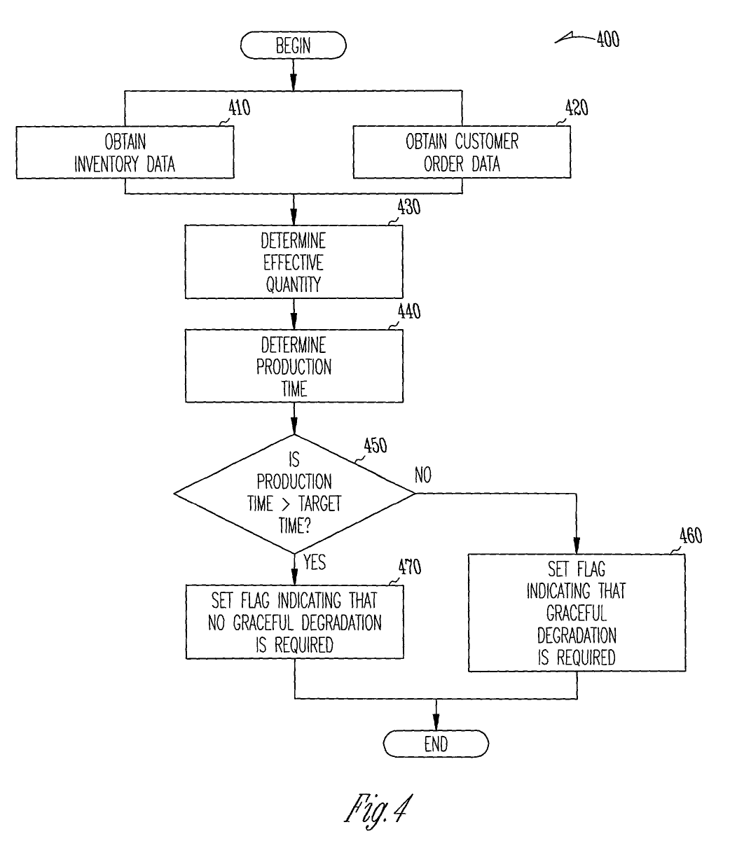

FIG. 4 is a flowchart of a method 400 of determining that the customer order exceeds production capacity, action 310 in FIG. 3, according to an embodiment of the invention. Method 400 includes the vendor obtaining 410 process and inventory operation data of the vendor. The process and inventory operation data includes an inventory quantity and an inventory identity for each inventory item. In one example, process and inventory data that includes two products, “A” and “B” is received, indicating inventory quantities of 10 and 14, respectively.

Method 400 also includes obtaining 420 customer order data. The customer order data includes an identification of each of a plurality of products, a requested quantity of each of the plurality of products, and an associated target time (T_{target}) of the order. In one example, a customer order specifying two products, “A” and “B” is received, indicating requested quantities of 666 and 999, respectively, and a target time, T_{target}, of 360 days.

In varying embodiments, obtaining 410 process and inventory operation data of the vendor is performed before, during, or after obtaining 420 customer order data is performed. For example, first the customer order data is obtained 420, and then the process and inventory operation data of the products identified in the customer order is obtained 410.

Subsequently, an effective quantity (Qₑ) for each of the plurality of products to be produced is determined 430, or calculated. Qₑ is calculated from the requested quantity of each of the plurality of products in the customer order obtained in action 420, and from the inventory quantity for each of the plurality of products obtained in action 410, such as by subtracting the inventory quantity from the requested quantity of each product in the customer order, as shown below in table 1:

TABLE 1
Qₑ = requested quantity − inventory quantity

For example, the Qₑ for products “A” and “B” is 656 (666-10) and 985 (999-14), respectively.

Thereafter, method 400 includes determining 440 an actual time (T_{actual}) to produce all of the plurality of products in the customer order. The actual time (T_{actual}) to produce all of the plurality of products in the customer order is also known as the production time. In one embodiment, T_{actual} is determined from the effective quantity (Qₑ) for each of the plurality of products to be produced in the customer order, and from, optionally from a measurement of the amount of time to produce each unit. In a further embodiment, the measurement is obtained from the inventory and process data. For example, the time to produce products “A” and “B” is determined to be 170.56 days and 315.2 days, respectively. T_{actual} is the sum of the times to produce products “A” and “B”, which is 486.23 days. Thereafter, a comparison 450 between the actual time (T_{actual}) to produce all of the plurality of products and the target time (T_{target}) is performed. T_{actual} is also known as production time. Where the comparison 450 determines that the actual time (T_{actual}) is less than or equal to the target time (T_{target}), the customer order does not exceed the production capacity of the vendor, and a flag indicating that no graceful degradation of production quantity is required 470. Where the comparison determines that the actual time (T_{actual}) is greater than or equal to the target time (T_{target}), the customer order does exceed production capacity of the vendor, and a flag indicating that graceful degradation of production quantity is required 460. In one example, where T_{target} is 360 days and T_{actual} is 486.23 days, after comparison 450 is performed, the flag indicating required graceful degradation of production quantity 460 is set.

In one embodiment of the comparison 450, the actual time (T_{actual}) is compared to determine if the target time (T_{target}) is within a predetermined percentage and/or an absolute quantity margin.

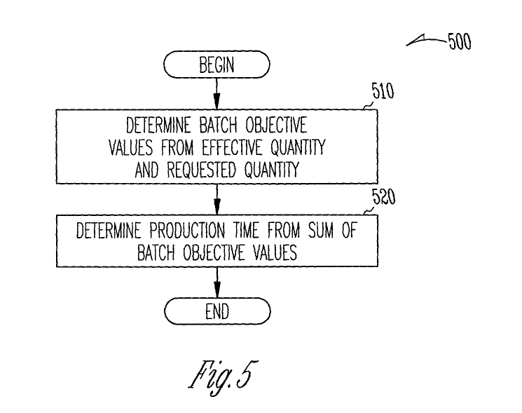

FIG. 5 is a flowchart of a method 500 of determining production time, action 440 in FIG. 4, according to an embodiment of the invention. Method 500 includes determining 510 a batch objective value (tᵢ) for producing and/or delivering each of the plurality of products. The batch objective value is determined or calculated from the effective quantity of the one or more products identified in the customer order, and from the production speed of each of the batches. For example, effective quantity, Qₑ, for products “A” and “B” is 656 and 985, respectively, and the production speed is 0.26 days/unit and 0.32 days/unit, respectively, the tᵢ is 656 units multiplied by 0.26 days/unit and 985 units multiplied by 0.32 days/unit, which is 170.56 days and 315.2 days, respectively, for products “A” and “B.”

Subsequently, the total production and/or delivery time of the plurality of products is determined or calculated 520. The total production time, T_{actual}, is determined or calculated from the sum of batch objective value (tᵢ) of each of the plurality of products in the customer order, as shown in Table 2:

TABLE 2
${T}_{actual} = {\sum }_{i = 1}^{number\_of \_products} {t}_{i}$

For example, the total production and/or delivery time for the customer order for products “A” and “B” is the sum of 170.56 days and 315.2 days, respectively, totaling 485.76 days.

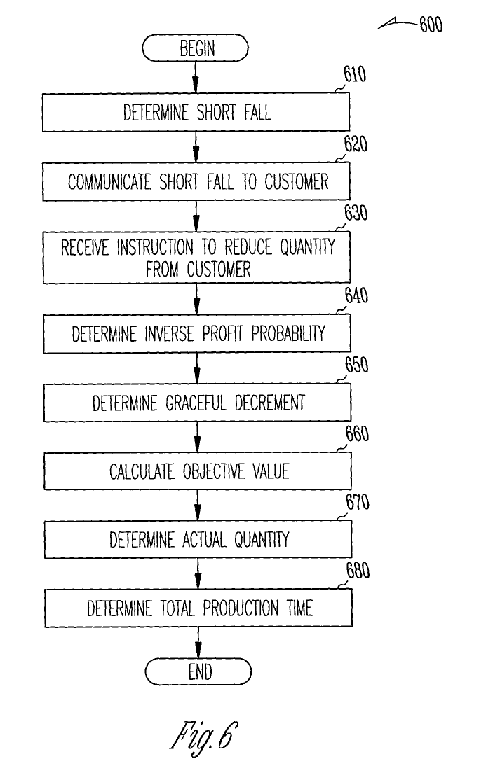

FIG. 6 is a flowchart of a method 600 of determining a quantity of each of the plurality of products corresponding to a vendor maximum profit of the requests for a plurality of products, action 320 in FIG. 3, according to an embodiment of the invention. Method 600 includes determining 610 a time shortfall (ΔT) in the production of each of the plurality of products from an actual time (T_{actual}) to produce all of the plurality of products to be produced, and from the target time (T_{target}) as shown below in table 3:

TABLE 3
ΔT = T_{actual} − T_{target}

For example, for products “A” and “B,” the ΔT is the difference between the T_{actual} of 485.76 days and the T_{target} of 360 days, which is 125.76 days. If no time shortfall is found at 610, then the method ends.

Thereafter, the time shortfall ΔT is communicated 620 to the customer. The communication is implemented in any of the following conventional manners: Email, fax, verbally in person or over a voice telephone line, or through a document delivery service. In one example, the ΔT value of 125.76 days is communicated to the customer.

Subsequently, method 600 includes receiving 630 from the customer, information representing an instruction to reduce the quantity associated with at least one of the plurality of products. If information representing an instruction to reduce the quantity is not received from the customer, the method ends.

Thereafter, a process of graceful degradation in reference to optimal vendor profit is performed.

Method 600 includes determining 640 or calculating, an inverse profit probability. The profit probability of a product indicates the portion of total profit of the order that will be derived from that product.

The profit probability is determined from a profit of one of the plurality of products in the customer order, and from the profit of all of the plurality of products in the customer order. The inverse profit probability of a product is the ratio of the profit for one of the products to the profit of all the products in the order, yielding the portion of total profit attributable to the one product, subtracted from 1, as shown in Table 4:

TABLE 4
$inverse\_profit \_probability = [ 1 - ( \frac{profit\_of \_one \_product \_in \_the \_customer \_order}{profit\_of \_the \_all \_of \_products \_in \_the \_order} ) ]$

For example, the profit probability of product “B” is 1- ($3996/($3330+$3996)), which is 0.454545, where the profit for product “A” is $3996, as the product of a gain of $4/unit and the requested quantity of 999 units, and the profit for product “B” is $3330, as the product of a gain of $5/unit and the requested quantity of 666 units. Determining 640 an inverse of a profit probability provides the element of the inverse profit probability to method 600.

Thereafter, a graceful decrement δtᵢ is determined 650. δtᵢ is determined or calculated for one of the products (ᵢ), for which the customer indicated a reduced quantity in action 630. δtᵢ is determined and/or calculated from the time shortfall (ΔT), from the inverse profit probability calculated in action 640, and from a decremented number of plurality of products, such as shown below in Table 5:

TABLE 5
${δt}_{i} = \frac{( ΔT ) * ( profit probabilty )}{( current number of products ) - 1}$

Each time method 600 is performed. For example, the graceful decrement for product “B” (δiₜ) is:

$$δ {t}_{2} = \frac{125.76 * 0.454545}{( 2 ) - 1} = 57.1630$$

Where the instruction received from the customer in action 630 indicates to reduce quantity of product “B” only, the graceful decrement for product “A” (δt₁) is 0.0.

Method 600 also includes updating the objective value (tᵢ) 660 for each product in the customer order. In one embodiment, the graceful decrement δtᵢ from the objective value (tᵢ), as shown in Table 6:

TABLE 6
updated tᵢ = tᵢ − δtᵢ

For example, for product “A”, the updated objective value, t₁ is 170.56, as 170.56−-0.00. For product “B”, the updated objective value, t₂ is 258.20, as 315.20−57.163.

Subsequently, method 600 also includes determining 670 the actual quantity (Q_{Ai}) to be produced for each of the plurality of products. The actual quantity (Q_{Ai}) for each product (i) is calculated or determined from the updated objective value, tᵢ, and from the unit time of manufacture (unit/time), as shown in Table 7:

TABLE 7
Q_{Ai} = ((objective value (tᵢ)) * (production speed)) + (inventory quantity)

For example, for product “A”, the actual quantity Q_{A1} is (170.565 days)*(0.26 days/unit)+(10 units)=666 units. For product “B”, the actual quantity Q_{A2} is (258.036 days)*(0.32 days/unit)+(14 units)=820.362 units.

Furthermore, the total production time T_{actual} is determined 680, using the formula in Table 2:

TABLE 2
${T}_{actual} = {\sum }_{i = 1}^{number\_of \_products} {t}_{i}$

For example, the total production and/or delivery time for the customer order for products “A” and “B” is the sum of 170.56 days and 258.036 days, respectively, totaling 428.596 days. Method 600 is performed indefinitely until either no time shortfall exists in action 610, or until the customer indicates that the customer did not communicate an instruction to further reduce quantity in action 630.

In one embodiment, methods 300-600 are implemented as a computer data signal embodied in a carrier wave, that represents a sequence of instructions which, when executed by a processor, such as processor 118 in FIG. 1, cause the processor to perform the respective method.

In another embodiment, methods 300-600 are implemented as a computer-readable medium having computer-executable instructions to cause a computer, such as computer 110, to perform the respective method. In yet another embodiment, methods 300-600 are implemented on a computer-accessible medium having executable instructions capable of directing a processor, such as processor 118 in FIG. 1, to perform the respective method.

Apparatus

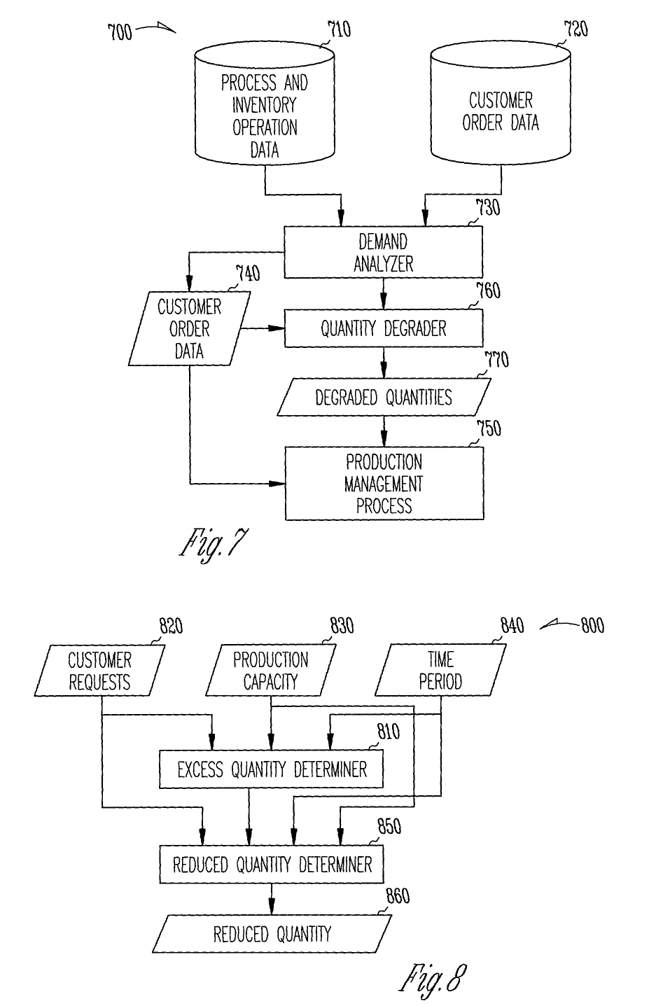

Referring to FIGS. 7-10, particular implementations of the invention are described in conjunction with the system overview in FIG. 2 and the methods described in conjunction with FIGS. 3, 5, and 6.

FIG. 7 is a block diagram of an apparatus 700 of an embodiment of the present invention. Embodiments of the invention operate in a multi-processing, multi-threaded operating environment on a computer, such as computer 110 in FIG. 1.

Apparatus 700 includes a database 710 including process and inventory operation data 710. Database 710 includes data that is substantially similar to the process and inventory operation data 210 of FIG. 210. Apparatus 700 also includes a database 720 including customer order data. Database 720 includes data that is substantially similar to the customer order data 220 in FIG. 2.

The process and inventory operation data and the customer order data are analyzed by the demand analyzer 730 to determine if the vendor can meet the customer product demand. The demand analyzer 730 performs an action substantially similar to the action of determining if the vendor can meet the customer product demand 230 in FIG. 2. If demand can be met, then the customer order data 740 is transmitted to a production management process 750.

If demand cannot be met, then the quantities in the customer order are gracefully degraded in reference to inverse probability of profit function by a quantity degrader 760. The graceful degradation attains certainty that the order will be fulfilled, and in reference to profits from each of the products in the order. Hence, apparatus 700 assures meeting a target value of an objective, while also completing the best possible efforts to meet the production demands from the customer. The quantity degrader performs an action that is substantially similar to the graceful degradation using an inverse probability of profit function 240 in FIG. 2. The graceful degradation of the quantity degrader yields a degraded quantity 770 that is received by the production management process 750. The production management process 750 controls the production and delivery of the goods identified in the customer order 740 using the degraded quantity 770.

Apparatus 700 has application in every industry that practices production and/or delivery management, such as petrochemical processing, chemical processing, pharmaceutical manufacturing, retail sales, service scheduling, such as airline crew scheduling, and supply chain management.

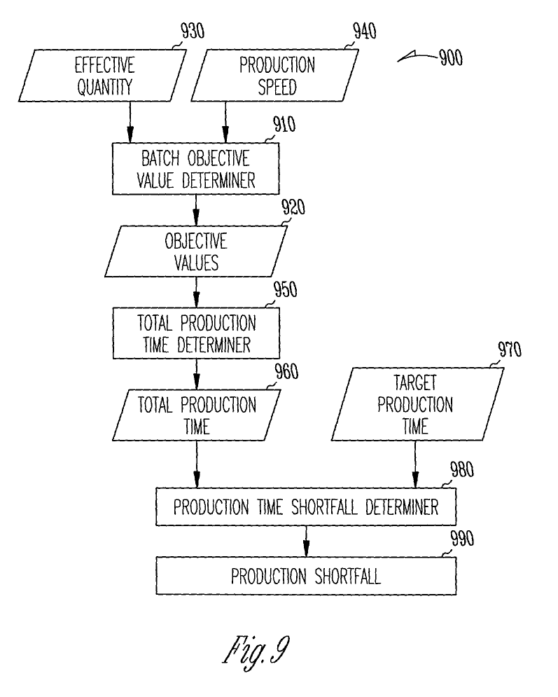

FIG. 8 is a block diagram of apparatus 800 for production management, according to an embodiment of the invention. Apparatus 800 enables a vendor to optimize or maximize profit from a customer order when the vendor cannot meet demand for at least one of the products in the order.

Apparatus 800 includes an excess quantity determiner 810 that determines that one or more requests 820 from the customer, for a plurality of products, exceed a production capacity 830 of the vendor within a prescribed time period 840. The one or more requests 820 include a quantity that is associated with each of a plurality of products identified in the order. The requests 820 are from customer order data that originates at the customer. The function of the excess quantity determiner 810 is substantially similar to the determining action 310 in FIG. 3.

A reduced quantity determiner 850 is operably coupled to the excess quantity determiner 810. The function of the reduced quantity determiner 850 is substantially similar to the determining action 320 in FIG. 3. A reduced quantity 860 of each of the plurality of products corresponds to a vendor maximum profit. The reduced quantity 860 is determined from a graceful degradation of the quantity associated with at least one of the plurality of products, using an inverse probability of profitability.

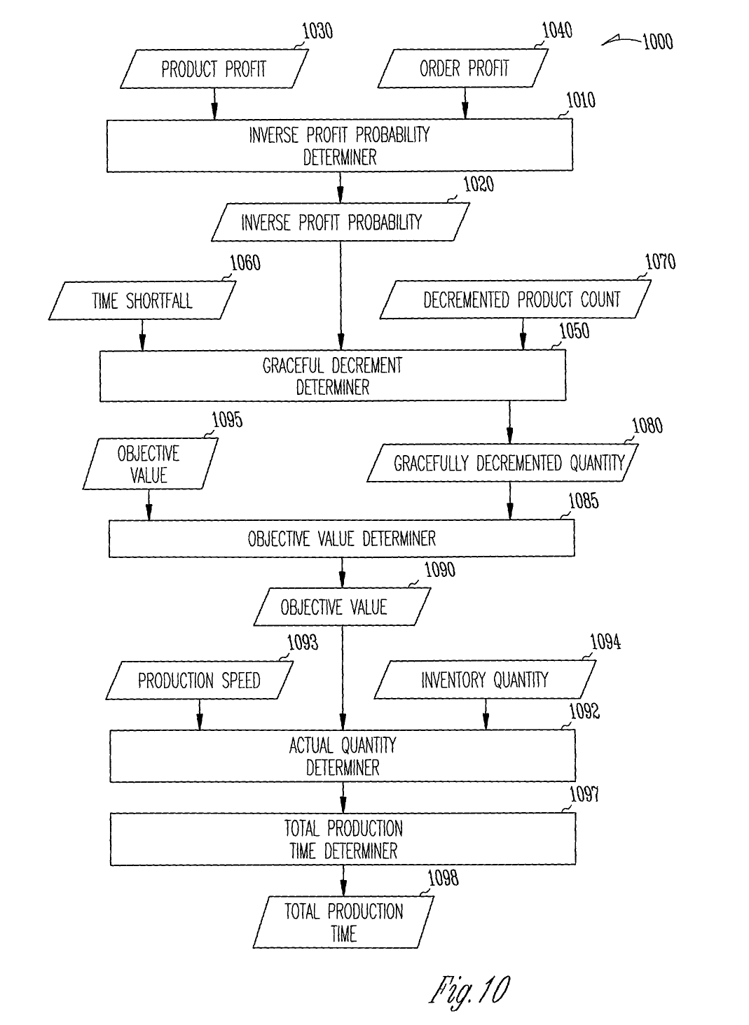

FIG. 9 is a block diagram of an apparatus 900 for determining that the customer order exceeds production capacity. Apparatus 900 is an excess quantity determiner 810 in FIG. 8, according to an embodiment of the invention. The function of the excess quantity determiner 900 is substantially similar to method 500 in FIG. 5.

Apparatus 900 includes a determiner 910 of batch objective values, tᵢ 920 for producing and/or delivering each of the plurality of products. The batch objective value 920 is determined or calculated from the effective quantity 930 of the one or more products identified in the customer order, and from the corresponding production speed 940 of each of the batches.

The determiner 910 is operably coupled to a determiner 950 of the actual total production and/or delivery time of the plurality of products is determined or calculated 920. The actual total production time, T_{actual}, is determined or calculated from the sum of batch objective value (tᵢ) of each of the plurality of products in the customer order.

The total production time determiner 950 is operably coupled to a determiner 980 of a production time shortfall (ΔT). A production shortfall 990 is determined or calculated from the actual total production time 960 time, T_{actual}, and a target production time 970, time (T_{target}). A production time shortfall indicates an excess quantity, wherein one or more requests from the customer, for a plurality of products, exceed a production capacity the vendor within the target time.

FIG. 10 is a flowchart of a reduced quantity determiner 1000, according to an embodiment of the invention. Determiner 1000 is one embodiment of the reduced quantity determiner 850 in FIG. 8. The function of determiner 1000 is substantially similar to action 320 in FIG. 3 and method 600 in FIG. 6. Determiner 1000 is operated when the customer has provided an indication to reduce the quantity associated with at least one of the plurality of products. Determiner 1000 provides graceful degradation of the quantity in reference to optimal vendor profit.

Determiner 1000 includes a determiner 1010 or calculator of an inverse profit probability. The determiner 1010 calculates the inverse profit probability 1020 from the projected profit of a product 1030 in a customer order, and from the profit of the entire customer order 1040. The function of determiner 1010 is substantially similar to the action of determining the inverse profit probability 640 in FIG. 6.

The determiner 1010 is coupled to a determiner 1050 of a gracefully decremented quantity 1080. The gracefully decremented quantity, δtᵢ 1080 is determined 1050 for one of the products (i), that the customer indicated a reduced quantity. δtᵢ is determined and/or calculated from a time shortfall, (ΔT) 1060, from the profit probability 1020, and from a decremented number of plurality of products 1070.

The gracefully decremented quantity determiner 1050 is coupled to a determiner 1085 of an objective value (tᵢ) 1090. The objective value, tᵢ, 1090 is determined for each product in the customer order. The objective value, tᵢ, 1090 is determined from the gracefully decremented quantity, δtᵢ, 1080, and from the objective value, tᵢ, 1095. The function of the objective value determiner 1085 is substantially similar to the action of determining the objective value 660 in FIG. 6.

The objective value determiner 1085 is operably coupled to an actual quantity determiner 1092. The actual quantity, Q_{Ai}, is determined from the objective value, tᵢ, 1090, from production speed 1093 of the product, and from the inventory quantity of the product 1094. The production speed 1093 is measured in terms of units/time.

A total production time determiner 1097 is operably coupled to the actual quantity determiner 1092. The total actual production time, T_{actual}, 1098 is determined as the sum of objective value, tᵢ, 1090 of each product (i).

Determiner 1000 performs indefinitely until either no time shortfall exists measured as the difference between a target time and the total actual production time 1098, or until the customer does not communicate an instruction to further reduce quantity.

The apparatus 700 components of the demand analyzer 730, and the quantity degrader 760, the apparatus 800 components of the excess quantity determiner 810 and the reduced quantity determiner 850, the apparatus components the batch objective value determiner 910, the total production time determiner 950, and the production time shortfall determiner 980, and the apparatus 1000 components of the inverse profit probability determiner 1010, the graceful decrement determiner 1050, the objective value determiner 1085, the actual quantity determiner 1092 and the total production time determiner 1097, can be embodied as computer hardware circuitry or as a computer-readable program, or a combination of both. In another embodiment, the apparatus is implemented in an Application Service Provider (ASP) system.

More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as Application Program Interfaces (A.P.I.) or interprocess communication techniques such as Remote Procedure Call (R.P.C.), Common Object Request Broker Architecture (CORBA), Component Object Model (COM), Distributed Component Object Model (DCOM), Distributed System Object Model (DSOM) and Remote Method Invocation (RMI). The components execute on as few as one computer as in computer 110 in FIG. 1, or on at least as many computers as there are component.

### CONCLUSION

A graceful decrementer of production quantity has been described. Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of the present invention. For example, although described in object-oriented terms, one of ordinary skill in the art will appreciate that the invention can be implemented in a procedural design environment or any other design environment that provides the required relationships.

Systems and methods are provided through which the quantity of one or more items in a customer order are reduced in reference to a function of inverse probability of vendor profit and in reference to a reasonable margin of a target time predetermined by the customer, when the customer order cannot be produced within the margin. The reduced item quantities update the corresponding items in the customer order, and the items in the customer order are produced accordingly.

In particular, one of skill in the art will readily appreciate that the names of the methods and apparatus are not intended to limit embodiments of the invention. Furthermore, additional methods and apparatus can be added to the components, functions can be rearranged among the components, and new components to correspond to future enhancements and physical devices used in embodiments of the invention can be introduced without departing from the scope of embodiments of the invention. One of skill in the art will readily recognize that embodiments of the invention are applicable to future communication devices, different file systems, and new data types. The terminology used in this application with respect to is meant to include all object-oriented, database and communication environments and alternate technologies that provide the same functionality as described herein. Therefore, it is manifestly intended that this invention be limited only by the following claims and equivalents thereof.

We claim:

1. A computerized method for production management comprising:
determining a reduced quantity of a requested product quantity in a customer order in reference to the inverse of the probability of profit of the product; and
communicating the reduced quantity to a production management process.

2. The computerized method of claim 1, wherein the determining further comprises:
iteratively determining a graceful reduction of the requested product quantity from a time shortfall, from the inverse profit probability, and from a reduced number of plurality of products, until the customer accepts the reduced quantity or until the time shortfall is non-existent.

3. The computerized method of claim 1, the method further comprising:
determining that the requested product quantity can not be satisfied within a customer target time period.

4. A computerized method for production management comprising:
(a) determining that at least one request for a plurality of products exceeds a production capacity of a vendor, wherein the request for a plurality of products includes a quantity associated with each of the plurality of products from process and inventory operation data and from customer order data; and
(b) determining a quantity of each of the plurality of products corresponding to a vendor maximum profit of the requests for a plurality of products, from a degradation of the quantity associated with at least one of the plurality of products.

5. The computerized method of claim 4, the method further comprising:
(c) communicating the quantity of each of the plurality of products corresponding to a maximum vendor profit of the requests for a plurality of products.

6. The computerized method of claim 4, wherein the determining (a) further comprises:
(a)(1) obtaining process and inventory operation data, the data further comprising an inventory quantity for each of the plurality of products;
(a)(2) obtaining customer order data; the data further comprising an identification of each of the plurality of products, a requested quantity of each of the plurality of products, and an associated target time of each of the plurality of requested products;
(a)(3) determining an effective quantity for each of the plurality of products to be produced from the requested quantity of each of the plurality of products and from the inventory quantity for each of the plurality of products;
(a)(4) determining an actual time to produce all of the plurality of products to be produced, from the effective quantity for each of the plurality of products to be produced; and
(a)(5) determining that at least one request for a plurality of products exceeds a production capacity of a vendor, from the effective quantity of the at least one of the plurality of products, from the requested quantity of the at least one of the plurality of products, and from the target time of the at least one of the plurality of products.

7. The computerized method of claim 6, wherein the obtaining (a)(1) action is performed after the obtaining (a)(2) action.

8. The computerized method of claim 6, wherein the determining (a)(5) further comprises:
(a)(5)(i) determining that at least one request for a plurality of products exceeds a production capacity of a vendor beyond a predetermined margin.

9. The computerized method of claim 6, wherein the determining (a)(5) further comprises:
(a)(5)(i) determining a batch objective value for producing and delivering each of the plurality of products, from the effective quantity of the at least one of the plurality of products, from the requested quantity of the at least one of the plurality of products;
(a)(5)(ii) determining the total production time of the plurality of products from the batch objective value of each of the plurality of products; and
(a)(5)(iii) comparing the target time to the total production time of the plurality of products.

10. The computerized method of claim 6, wherein the predetermined margin further comprises a predetermined absolute quantity margin.

11. The computerized method of claim 4, wherein determining (b) for each product in the order, further comprises:
(b)(1) determining a time shortfall in the production of each of the plurality of products from actual time to produce all of the plurality of products to be produced, and from the target time;
(b)(2) communicating to the customer each of the time shortfalls;
(b)(3) receiving from the customer information representing reduction in the quantity associated with at least one of the plurality of products;
(b)(4) determining a profit probability from the profit of a production of one of the plurality of products in the customer order, and from the profit of all of the plurality of products in the customer order;
(b)(5) determining a graceful decrement from the time shortfall, from the profit probability, and from a decremented number of plurality of products;
(b)(6) updating the objective value from the graceful decrement;
(b)(7) determining the actual quantity to be produced for each of the plurality of products, from the graceful decrement, and from the unit time of manufacture; and
(b)(8) determining an actual time to produce all of the plurality of products to be produced, from the actual quantity to be produced for each of the plurality of products.

12. The computerized method of claim 11, wherein determining (b)(4), further comprises:
(b)(4)(i) dividing the profit of a production of one of the plurality of products in the customer order into the profit of all of the plurality of products in the customer order, yielding a portion of total profit attributable to the one product; and
(b)(4)(ii) determining a profit probability from the portion of total profit attributable to the one product subtracted from (b)(4)(i)

13. A computerized method for production management comprising:
(a) determining that at least one request for a plurality of products exceeds a production capacity of a vendor, wherein the request for a plurality of products includes a quantity associated with each of the plurality of products from process and inventory operation data
(b) determining an inverse profit probability from the profit of a production of one of the plurality of products in the request, and from the profit of all of the plurality of products in the customer order;
(c) determining a graceful decrement from the time shortfall, from the inverse profit probability, and from a decremented number of plurality of products;
(d) updating the objective value from the graceful decrement;
(e) determining the actual quantity to be produced for each of the plurality of products, from the graceful decrement; and
(f) determining an actual time to produce all of the plurality of products to be produced, from the actual quantity to be produced for each of the plurality of products.

14. The computerized method of claim 13, wherein the determining (a) further comprises:
(a)(1) determining that at least one request for a plurality of products exceeds a production capacity of a vendor beyond a predetermined margin, from the effective quantity of the at least one of the plurality of products, from the requested quantity of the at least one of the plurality of products, and from the target time of the at least one of the plurality of products.

15. The computerized method of claim 14, wherein the determining (a)(1) further comprises:
(a)(1)(i) determining a batch objective value for producing and delivering each of the plurality of products, from the effective quantity of the at least one of the plurality of products, from the requested quantity of the at least one of the plurality of products;
(a)(1)(ii) determining the total production time of the plurality of products from the batch objective value of each of the plurality of products; and
(a)(1)(iii) comparing the target time to the total production time of the plurality of products.

16. The computerized method of claim 14, wherein the determining (a)(1) further comprises:
(a)(1)(i) obtaining process and inventory operation data, the data further comprising an inventory quantity for each of the plurality of products;
(a)(1)(ii) obtaining customer order data; the data further comprising an identification of each of the plurality of products, a requested quantity of each of the plurality of products, and an associated target time of each of the plurality of requested products;
(a)(1 )(iii) determining an effective quantity for each of the plurality of products to be produced from the requested quantity of each of the plurality of products and from the inventory quantity for each of the plurality of products; and
(a)(1 )(iv) determining an actual time to produce all of the plurality of products to be produced, from the effective quantity for each of the plurality of products to be produced.

17. The computerized method of claim 14, wherein the predetermined margin further comprises an absolute quantity margin.

18. The computerized method of claim 13, wherein the method further comprises:
(g) determining a time shortfall in the production of each of the plurality of products from actual time to produce all of the plurality of products to be produced, and from the target time;
(h) communicating to the customer each of the time shortfalls; and
(i) receiving from the customer information representing a reduction in the quantity associated with at least one of the plurality of products.

19. A computer-readable medium having computer-executable instructions to cause a computer to perform a method for production management comprising:
determining a reduced quantity of a requested product quantity in a customer order in reference to the inverse of the probability of profit of the product; and
communicating the reduced quantity to a production management process.

20. The computer-readable medium of claim 19, wherein the determining further comprises:
iteratively determining a graceful reduction of the requested product quantity from a time shortfall, from the inverse profit probability, and from a reduced number of plurality of products, until the customer accepts the reduced quantity or until the time shortfall is non-existent.

21. The computer-readable medium of claim 19, the method further comprising:
determining that the requested product quantity can not be satisfied within a customer target time period.

22. A computer-readable medium having computer-executable instructions to cause a computer to perform a method for production management comprising:
(a) determining that at least one request for a plurality of products exceeds a production capacity of a vendor, wherein the request for a plurality of products includes a quantity associated with each of the plurality of products from process and inventory operation data and from customer order data; and
(b) determining a quantity of each of the plurality of products corresponding to a vendor maximum profit of the requests for a plurality of products, from a degradation of the quantity associated with at least one of the plurality of products.

23. The computer-readable medium of claim 22, the method further comprising:
(c) communicating the quantity of each of the plurality of products corresponding to a maximum vendor profit of the requests for a plurality of products.

24. The computer-readable medium of claim 22, wherein the determining (a) further comprises:
(a)(1) obtaining process and inventory operation data, the data further comprising an inventor quantity for each of the plurality of products;
(a)(2) obtaining customer order data; the data further comprising an identification of each of the plurality of products, a requested quantity of each of the plurality of products, and an associated target time of each of the plurality of requested products;
(a)(3) determining an effective quantity for each of the plurality of products to be produced from the requested quantity of each of the plurality of products and from the inventory quantity for each of the plurality of products;
(a)(4) determining an actual time to produce all of the plurality of products to be produced, from the effective quantity for each of the plurality of products to be produced; and
(a)(5) determining that at least one request for a plurality of products exceeds a production capacity of a vendor, from the effective quantity of the at least one of the plurality of products, from the requested quantity of the at least one of the plurality of products, and from the target time of the at least one of the plurality of products.

25. The computer-readable medium of claim 24, wherein the obtaining (a)(1) action is performed after the obtaining (a)(2) action.

26. The computer-readable medium of claim 24, wherein the determining (a)(5) further comprises:
(a)(5)(i) determining that at least one request for a plurality of products exceeds a production capacity of a vendor beyond a predetermined margin.

27. The computer-readable medium of claim 24, wherein the determining (a)(5) further comprises:
(a)(5)(i) determining a batch objective value for producing and delivering each of the plurality of products, from the effective quantity of the at least one of the plurality of products, from the requested quantity of the at least one of the plurality of products;
(a)(5)(ii) determining the total production time of the plurality of products from the batch objective value of each of the plurality of products; and
(a)(5)(iii) comparing the target time to the total actual production time of the plurality of products.

28. The computer-readable medium of claim 24, wherein the predetermined margin further comprises a predetermined absolute quantity margin.

29. The computer-readable medium of claim 22, wherein determining (b) for each product in the order, further comprises:
(b)(1) determining a time shortfall in the production of each of the plurality of products from actual time to produce all of the plurality of products to be produced, and from the target time;
(b)(2) communicating to the customer each of the time shortfalls;
(b)(3) receiving from the customer information representing reduction in the quantity associated with at least one of the plurality of products;
(b)(4) determining a profit probability from the profit of a production of one of the plurality of products in the customer order, and from the profit of all of the plurality of products in the customer order;
(b)(5) determining a graceful decrement from the time shortfall, from the profit probability, and from a decremented number of plurality of products;
(b)(6) updating the objective value from the graceful decrement;
(b)(7) determining the actual quantity to be produced for each of the plurality of products, from the graceful decrement; and
(b)(8) determining an actual time to produce all of the plurality of products to be produced, from the actual quantity to be produced for each of the plurality of products.

30. The computer-readable medium of claim 29, wherein determining (b)(4), further comprises:
(b)(4)(i) dividing the profit of a production of one of the plurality of products in the customer order into the profit of all of the plurality of products in the customer order, yielding a portion of total profit attributable to that one product; and
(b)(4)(ii) determining a profit probability from the portion of total profit attributable to the one product subtracted from (b)(4)(i)

31. A computer-readable medium having computer-executable instructions to cause a computer to perform a method for production management comprising:
(a) determining that at least one request for a plurality of products exceeds a production capacity of a vendor, wherein the request for a plurality of products includes a quantity associated with each of the plurality of products from process and inventory operation data
(b) determining a profit probability from the profit of a production of one of the plurality of products in the request, and from the profit of all of the plurality of products in the customer order;
(c) determining a graceful decrement from the time shortfall, from the profit probability, and from a decremented number of plurality of products;
(d) updating the objective value from the graceful decrement;
(e) determining the actual quantity to be produced for each of the plurality of products, from the graceful decrement; and
(f) determining an actual time to produce all of the plurality of products to be produced, from the actual quantity to be produced for each of the plurality of products.

32. The computer-readable medium of claim 31, wherein the determining (a) further comprises:
(a)(1) determining that at least one request for a plurality of products exceeds a production capacity of a vendor beyond a predetermined margin, from the effective quantity of the at least one of the plurality of products, from the requested quantity of the at least one of the plurality of products, and from the target time of the at least one of the plurality of products.

33. The computer-readable medium of claim 32, wherein the determining (a)(1) further comprises:
(a)(1)(i) determining a batch objective value for producing and delivering each of the plurality of products, from the effective quantity of the at least one of the plurality of products, from the requested quantity of the at least one of the plurality of products;
(a)(1)(ii) determining the total production time of the plurality of products from the batch objective value of each of the plurality of products; and
(a)(1 )(iii) comparing the target time to the total production time of the plurality of products.

34. The computer-readable medium of claim 32, wherein the determining (a)(1) further comprises:
(a)(1)(i) obtaining process and inventory operation data, the data further comprising an inventory quantity for each of the plurality of products;
(a)(1)(ii) obtaining customer order data; the data further comprising an identification of each of the plurality of products, a requested quantity of each of the plurality of products, and an associated target time of each of the plurality of requested products;
(a)(1 )(iii) determining an effective quantity for each of the plurality of products to be produced from the requested quantity of each of the plurality of products and from the inventory quantity for each of the plurality of products; and
(a)(1)(iv) determining an actual time to produce all of the plurality of products to be produced, from the effective quantity for each of the plurality of products to be produced.

35. The computer-readable medium of claim 32, wherein the predetermined margin further comprises an absolute quantity margin.

36. The computer-readable medium of claim 31, wherein the method further comprises:
(g) determining a time shortfall in the production of each of the plurality of products from actual time to produce all of the plurality of products to be produced, and from the target time;
(h) communicating to the customer each of the time shortfalls; and
(i) receiving from the customer information representing a reduction in the quantity associated with at least one of the plurality of products.

37. A computer data signal embodied in a carrier wave and representing a sequence of instructions which, when executed by a processor, cause the processor to perform the method of:
(a) determining that at least one request for a plurality of products exceeds a production capacity of a vendor, wherein the request for a plurality of products includes a quantity associated with each of the plurality of products from process and inventory operation data;
(b) determining an inverse profit probability from the profit of a production of one of the plurality of products in the request, and from the profit of all of the plurality of products in the customer order;
(c) determining a graceful decrement from the time shortfall, from the inverse profit probability, and from a decremented number of plurality of products;
(d) updating the objective value from the graceful decrement;
(e) determining the actual quantity to be produced for each of the plurality of products, from the graceful decrement, and from the unit time of manufacture; and
(f) determining an actual time to produce all of the plurality of products to be produced, from the actual quantity to be produced for each of the plurality of products.

38. The computer data signal of claim 37, wherein the determining (a) further comprises:
(a)(1) determining that at least one request for a plurality of products exceeds a production capacity of a vendor beyond a predetermined margin, from the effective quantity of the at least one of the plurality of products, from the requested quantity of the at least one of the plurality of products, and from the target time of the at least one of the plurality of products.

39. A computer-readable medium having stored thereon an data structure representing a reduced quantity of a requested product quantity produced by a method comprising:
determining that the quantity of the requested product can not be satisfied by a vendor within a customer target time period; and
iteratively determining a graceful reduction of the requested product quantity from a time shortfall, from the inverse profit probability, and from a reduced number of plurality of products, until the customer accepts the reduced quantity or until the time shortfall is non-existent.

40. The computer-readable medium of claim 39, produced by the method further comprising:
communicating the reduced quantity to a vendor production process.

41. The computer-readable medium of claim 39, wherein the determining further comprises:
determining that at least one request for a plurality of products exceeds a production capacity of the vendor beyond a predetermined margin.

42. The computer-readable medium of claim 39, wherein the determining further comprises:
determining a time shortfall in the production of each of the plurality of products from actual time to produce all of the plurality of products to be produced, and from the target time;
communicating to the customer each of the time shortfalls;
receiving from the customer information representing reduction in the quantity associated with at least one of the plurality of products;
determining a profit probability from the profit of a production of one of the plurality of products in the customer order, and from the profit of all of the plurality of products in the customer order;
determining a graceful decrement from the time shortfall, from the profit probability, and from a decremented number of plurality of products;
updating the objective value from the graceful decrement;
determining the actual quantity to be produced for each of the plurality of products, from the graceful decrement, and from the unit time of manufacture; and
determining an actual time to produce all of the plurality of products to be produced, from the actual quantity to be produced for each of the plurality of products.

43. A computer-readable medium having stored thereon an data structure representing a reduced quantity of a requested product quantity produced by a method comprising:
(a) determining that at least one request for a plurality of products exceeds a production capacity of a vendor, wherein the request for a plurality of products includes a quantity associated with each of the plurality of products from process and inventory operation data
(b) determining a profit probability from the profit of a production of one of the plurality of products in the request, and from the profit of all of the plurality of products in the customer order;
(c) determining a reduced quantity from the time shortfall, from the profit probability, and from a decremented number of plurality of products;
(d) updating the objective value from the reduced quantity;
(e) determining the actual quantity to be produced for each of the plurality of products, from the reduced quantity, and from the unit time of manufacture; and
(f) determining an actual time to produce all of the plurality of products to be produced, from the actual quantity to be produced for each of the plurality of products.

44. The computer-readable medium of claim 43, wherein the determining (a) further comprises:
(a)(1) determining that at least one request for a plurality of products exceeds a production capacity of a vendor beyond a predetermined margin, from the effective quantity of the at least one of the plurality of products, from the requested quantity of the at least one of the plurality of products, and from the target time of the at least one of the plurality of products.

45. The computer-readable medium of claim 43, wherein the method further comprises:
(g) determining a time shortfall in the production of each of the plurality of products from actual time to produce all of the plurality of products to be produced, and from the target time;
(h) communicating to the customer each of the time shortfalls; and
(i) receiving from the customer information representing reduction in the quantity associated with at least one of the plurality of products.

46. A system for transacting in electronic commerce comprising:
a processor; and
software means operative on the processor for degrading the quantity of an order of a plurality of products using an inverse probability of profit function in reference to profits from each of the products in the order.

47. A computerized apparatus for production management comprising:
a demand analyzer, that determines if a vendor can satisfy a quantity of customer demand for a product, from a database of process and inventory operation data and from a database of customer order data; and
a graceful quantity degrader, operably coupled to the demand analyzer, that yields a degraded quantity from the quantity of customer demand using an inverse probability of profit function.

48. The computerized apparatus of claim 47, wherein the graceful quantity degrader yields the degraded quantity for each of the products that the customer indicated a reduced quantity thereof, from a time shortfall, the inverse probability of profit, and from a decremented number of plurality of products of the customer order.

49. A computerized apparatus for production management comprising:
an excess quantity determiner, that determines that one or more customer requests for a plurality of products, exceed a production capacity of the vendor within a prescribed time period; and
a reduced quantity determiner, operably coupled to the excess quantity determiner, that yields a reduced quantity, from an inverse probability of profit of the reduced quantity.

50. The computerized apparatus of claim 49, wherein the excess quantity determiner further comprises:
a determiner of batch objective values, from an effective quantity of at least one product identified in the request, and from the corresponding production speed of each of a plurality of product batches in the request;
a determiner of actual total production time of the at least one products in the request, from the sum of the batch objective values; and
a determiner of a production time shortfall, from the actual total production time, and a target production time, wherein the production shortfall indicates an excess quantity.

51. The computerized apparatus of claim 49, wherein the reduced quantity determiner further comprises:
an inverse profit probability determiner, wherein the inverse profit probability is determined from a projected profit of a product in a customer order, and from the profit of the entire customer order;
a gracefully-decremented quantity determiner, operably coupled to the inverse profit probability determiner, wherein the gracefully-decremented quantity is determined for each of the products that the customer indicated a reduced quantity, and determined from a time shortfall, the inverse profit probability, and from a decremented number of plurality of products;
an objective-value determiner, operably coupled to the gracefully-decremented quantity determiner, wherein the objective-value is determined for each product in the customer order from the gracefully-decremented quantity, and from the previous objective value;
an actual-quantity determiner, operably coupled to the objective-value determiner, wherein the actual-quantity is determined from the objective-value, a production speed of the product, and from the inventory quantity of the product; and
a total-production-time determiner, operably coupled to the actual-quantity determiner, wherein the total-production-time is determined as the sum of objective value of each product.

52. A computerized apparatus for production management comprising:
an excess quantity determiner, that determines that one or more customer requests for a plurality of products exceed a production capacity of the vendor within a prescribed time period;
a reduced quantity determiner, operably coupled to the excess quantity determiner, that yields a reduced quantity, from an inverse probability of profit of the reduced quantity, wherein the reduced quantity determiner further comprises:
a gracefully-decremented quantity determiner, yielding a reduced quantity, operably coupled to the inverse profit probability determiner, wherein the gracefully-decremented quantity is determined for each of the products that the customer indicated a reduced quantity, and determined from a time shortfall, the inverse probability of profit, and from a decremented number of plurality of products.

53. The computerized apparatus of claim 52, wherein the inverse profit probability is determined from a projected profit of a product in the customer request, and from the profit of the entire customer request.

54. A computer-readable medium comprising:
a demand analyzer, that determines if a vendor can satisfy a quantity of customer demand for a product, from a database of process and inventory operation data and from a database of customer order data; and
a graceful quantity degrader, operably coupled to the demand analyzer, that yields a degraded quantity from the quantity of customer demand using an inverse probability of profit function

55. The computer-readable medium of claim 54, wherein the graceful quantity degrader yields the degraded quantity for each of the products that the customer indicated a reduced quantity thereof, from a time shortfall, the inverse probability of profit, and from a decremented number of plurality of products of the customer order.

56. A computer-readable medium comprising:
an excess quantity determiner, that determines that one or more customer requests for a plurality of products, exceed a production capacity of the vendor within a prescribed time period; and
a reduced quantity determiner, operably coupled to the excess quantity determiner, that yields a reduced quantity, from an inverse probability of profit of the reduced quantity.

57. The computer-readable medium of claim 56, wherein the excess quantity determiner further comprises:
a determiner of batch objective values, from an effective quantity of at least one product identified in the request, and from the corresponding production speed of each of a plurality of product batches in the request;
a determiner of actual total production time of the at least one products in the request, from the sum of the batch objective values; and
a determiner of a production time shortfall, from the actual total production time, and a target production time, wherein the production shortfall indicates an excess quantity.

58. The computer-readable medium of claim 56, wherein the reduced quantity determiner further comprises:
an inverse profit probability determiner, wherein the inverse profit probability is determined from a projected profit of a product in a customer order, and from the profit of the entire customer order;
a gracefully-decremented quantity determiner, operably coupled to the inverse profit probability determiner, wherein the gracefully-decremented quantity is determined for each of the products that the customer indicated a reduced quantity, and determined from a time shortfall, the inverse profit probability, and from a decremented number of plurality of products;
an objective-value determiner, operably coupled to the gracefully-decremented quantity determiner, wherein the objective-value is determined for each product in the customer order from the gracefully-decremented quantity, and from the previous objective value;
an actual-quantity determiner, operably coupled to the objective-value determiner, wherein the actual-quantity is determined from the objective-value, a production speed of the product, and from the inventory quantity of the product; and
a total-production-time determiner, operably coupled to the actual-quantity determiner, wherein the total-production-time is determined as the sum of objective value of each product.

59. A computer-readable medium comprising:
an excess quantity determiner, that determines that one or more customer requests for a plurality of products exceed a production capacity of the vendor within a prescribed time period;
a reduced quantity determiner, operably coupled to the excess quantity determiner, that yields a reduced quantity, from an inverse probability of profit of the reduced quantity, wherein the reduced quantity determiner further comprises:
a gracefully-decremented quantity determiner, yielding a reduced quantity, operably coupled to the inverse profit probability determiner, wherein the gracefully-decremented quantity is determined for each of the products that the customer indicated a reduced quantity, and determined from a time shortfall, the inverse probability of profit, and from a decremented number of plurality of products.

60. The computer-readable medium of claim 59, wherein the inverse profit probability is determined from a projected profit of a product in the customer request, and from the profit of the entire customer request.
